(19) United States
(12) Patent Application Publication
(10) Pub. No.: US 2010/0058171 A1
(43) Pub. Date: Mar. 4, 2010

(54) METHOD AND SYSTEM FOR DRIVING EXTENSIBLE MARKUP LANGUAGE APPLICATION ON WEB BROWSER

(75) Inventors: Hong-Yang Tsai, Taipei (TW); Ying-Chi Huang, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Esobi Inc., George Town (KY)

(21) Appl. No.: 12/553,926

(22) Filed: Sep. 3, 2009

(30) Foreign Application Priority Data
Sep. 4, 2008 (CN) 200810146694.4

(51) Int. Cl. G06F 17/00

(52) U.S. Cl. 715/234

(57) ABSTRACT

A method and system for driving an Extensible Markup Language (XML) application on a web browser are applied to install a kit on the web browser in a non-intrusive manner. The method includes the following steps. A request of downloading a Hypertext Transfer Protocol (HTTP) based on an XML data stream is sent by the web browser of the client. A data stream based on a tag is received on the web browser of the client, and used for determining whether the web browser of the client satisfies a preset installation condition or not. If the web browser of the client satisfies the preset installation condition, the XML application is driven in the non-intrusive manner. If the web browser of the client does not satisfy the preset installation condition, the web browser of the client is redirected to a web address displaying a specific message.

### CROSS-REFERENCE TO RELATED APPLICATIONS

This non-provisional application claims priority under 35 U.S.C. § 119(a) on Patent Application No(s). 200810146694.4 filed in China, P.R.C. on Sep. 4, 2008, the entire contents of which are hereby incorporated by reference.

### BACKGROUND OF THE INVENTION

1. Field of the Invention

The present invention relates to a technology of driving an application on a web browser, and more particularly to a method and system for driving an Extensible Markup Language (XML) application on a web browser in a non-intrusive manner.

2. Related Art

The Extensible Markup Language (XML) is a standard for organizing and describing data, so as to enable a computer to easily generate and read the data, and ensure the data structure to be accurate. In an environment of a web browser, an existing technology for driving an XML application is to detect whether the XML application is installed in an operating system of the web browser by using a Microsoft's web page technology of ActiveX components, and if yes, drive the installed XML application; otherwise, prompt the user that the XML application is not installed.

However, in the existing technology, the ActiveX components need to be implanted in the web page to detect configuration information about the operating system of the web browser, so as to determine whether the XML application is installed or not. Therefore, this technology is an intrusive technology of low security, and may not be applied to a web browser in which ActiveX components cannot be implanted.

### SUMMARY OF THE INVENTION

In order to solve the above problems, the present invention is a method for driving an Extensible Markup Language (XML) application on a web browser.

The present invention provides a method for driving an XML application on a web browser, which comprises the following steps. A Hypertext Transfer Protocol (HTTP) request is sent by the web browser of the client (thereunder, call the “client” for the “web browser of the client”) to a corresponding web server. After receiving the HTTP request from the client, the web server adds an XML file of a processing instruction declaration to a content body of an HTTP file to be responded, adds a set value to a response header of the XML file, in which the set value is the same as a Multipurpose Internet Mail Extensions (MIME) protocol type registered in an operating system of the client through the XML application, and returns the responded HTTP file to the client after adding a content disposition declaration to the response header. After receiving the HTTP file responded by the web server, the client determines whether the XML application is installed on the client or not, and triggers the XML application to interpret the HTTP file if the XML application is installed. If the XML application is not installed, the client is redirected to a web address displaying a specific message.

The present invention is further a system for driving an XML application on a web browser.

According to an embodiment of the present invention, the system for driving an XML application on a web browser comprises a browser processing unit and a server processing unit. The browser processing unit is installed on the client, and comprises a registration module, a first transceiver module, a determination module, and a redirecting module. The registration module is used for registering a filename extension and an MIME protocol type related to the XML application in an operating system of the client. The first transceiver module is used for transmitting a request of downloading an HTTP based on an XML file, and receiving an HTTP file returned by the web server. The determination module is used for determining whether the client satisfies a preset installation condition or not, and triggering the XML application to interpret the HTTP file if the client satisfies the preset installation condition. If the client does not satisfy the preset installation condition, the redirecting module is used for redirecting the client to a web address displaying a specific message. The preset installation condition is that the XML application is installed on the client, and the registration module registers the filename extension and the MIME protocol type. The server processing unit is installed on the web server, and comprises a second transceiver module, an analyzing module, and a file processing module. The second transceiver module is used for receiving the HTTP request sent by the client, and transmitting the processed HTTP file. The analyzing module is used for analyzing the HTTP request, so as to determine a processing mode for the HTTP file. If an analysis result indicates that the client satisfies the preset installation condition, the file processing module generates a standard XML file, and the HTTP file is the standard XML file.

### BRIEF DESCRIPTION OF THE DRAWINGS

The present invention will become more fully understood from the detailed description given herein below for illustration only, and thus are not limitative of the present invention, and wherein:

FIG. 1 is a schematic structural view of the present invention;

FIG. 2 is a schematic view of an operating process according to the present invention; and

FIG. 3 is a schematic view of an operating process of a web server and a browser.

### DETAILED DESCRIPTION OF THE INVENTION

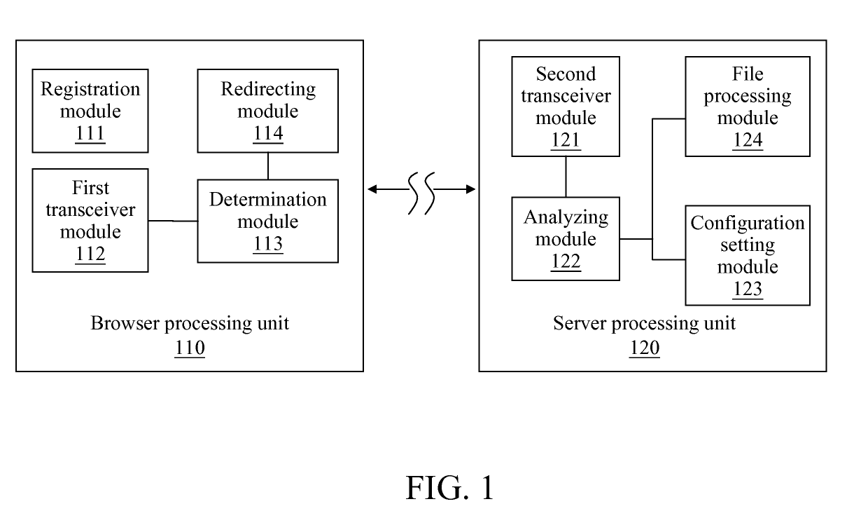

FIG. 1 is a schematic structural view of the present invention. Referring to FIG. 1, a system according to the present invention comprises a browser processing unit 110 and a server processing unit 120. The browser processing unit 110 is installed on a web browser of the client (thereunder, call the “client” for the “web browser of the client”), and the browser processing unit 110 comprises a registration module 111, a first transceiver module 112, a determination module 113, and a redirecting module 114.

The registration module 111 is used for registering a filename extension and an MIME protocol type related to the XML application in an operating system of the client. The first transceiver module 112 is used for transmitting a request of downloading an HTTP based on an XML file, and receiving an HTTP file returned by the web server. The HTTP file is a packet structure composed of a response header and a content body.

The determination module 113 is used for determining whether the client satisfies a preset installation condition or not, and triggering the XML application to interpret the HTTP file if the client satisfies the preset installation condition. If the client does not satisfy the preset installation condition, the redirecting module 114 is used for redirecting the client to a web address displaying a specific message. The redirecting module 114 triggers an Extensible Style Language (XSL) resource file event according to the processing instruction declaration of the XML file, so as to redirect the client to the web address displaying the specific message. The redirecting module 114 performs a corresponding process according to the preset installation condition. The preset installation condition is that the XML application is installed on the client, and the registration module 111 registers the filename extension and the MIME protocol type.

The server processing unit 120 is installed on the web server, and comprises a second transceiver module 121, an analyzing module 122, a configuration setting module 123, and a file processing module 124. The second transceiver module 121 is used for receiving the HTTP request sent by the client, and transmitting the processed HTTP file. The analyzing module 122 is used for analyzing the HTTP request, so as to determine a processing mode for the HTTP file.

If it is analyzed by the analyzing module 122 that the client satisfies the preset installation condition, the file processing module 124 generates a standard XML file, and the HTTP file is the standard XML file. If it is analyzed by the analyzing module 122 that the client is unidentifiable, the file processing module 124 further generates a Hypertext Markup Language (HTML) format file, and the HTTP file is the HTML format file. In addition to setting a configuration profile of the web server, the configuration setting module 123 is further used for adding to the profile a set value the same as the MIME protocol type registered in the operating system of the client.

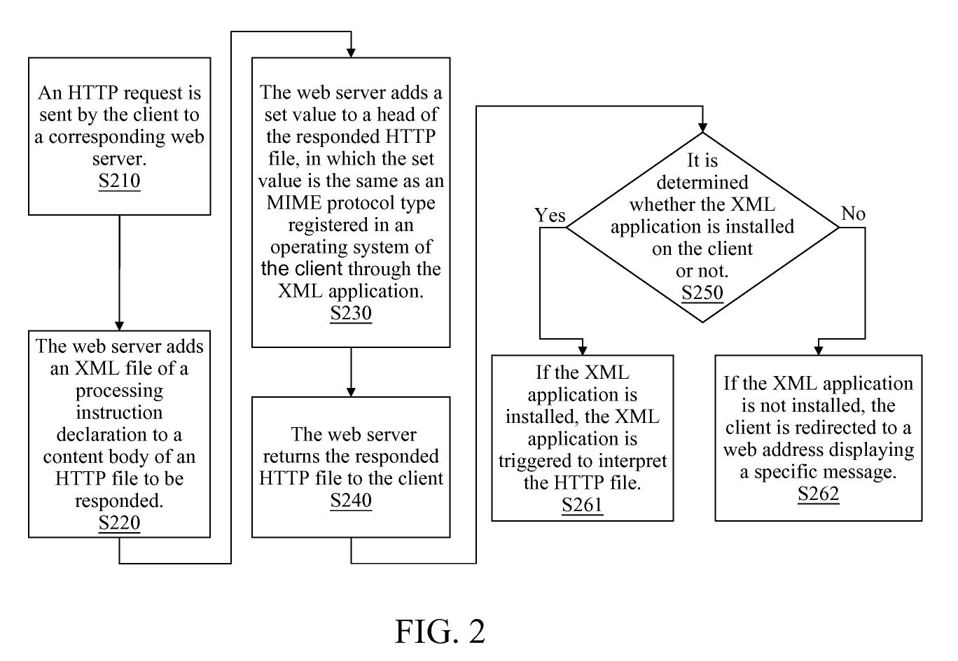

Relations among the units and modules in the system of the present invention and implementations thereof are further illustrated below through the method for driving an XML application on a client in a non-intrusive manner according to the present invention. FIG. 2 is a schematic view of an operating process according to the present invention. Referring to FIG. 2, an HTTP request is sent by a client to a corresponding web server (Step S210). After the web server receives the HTTP request from the client, a file processing module adds an XML file of a processing instruction declaration to a content body of an HTTP file to be responded (Step S220).

The file processing module adds a set value to a head of the responded HTTP file, in which the set value is the same as an MIME protocol type registered in an operating system of the client through the XML application (Step S230). The web server returns the responded HTTP file to the client after the file processing module adds a content disposition declaration to the response header (Step S240). In this embodiment of the present invention, after the content disposition declaration is added to the response header of the HTTP, a filename extension of the HTTP file is made into an XML format.

After the client receives the HTTP file responded by the web server, the determination module determines whether the XML application is installed on the client or not (Step S250). If the XML application is installed, the determination module triggers the XML application to interpret the HTTP file (Step S261). If the XML application is not installed, the client is redirected to a web address displaying a specific message (Step S262). In this embodiment of the present invention, a triggering mode is to automatically drive the XML application through a Microsoft's Object Linking and Embedding (OLE) technology according to the filename extension of the HTTP and the MIME protocol type. In addition, the specific message is used for notifying a user that the XML application is not installed on the client.

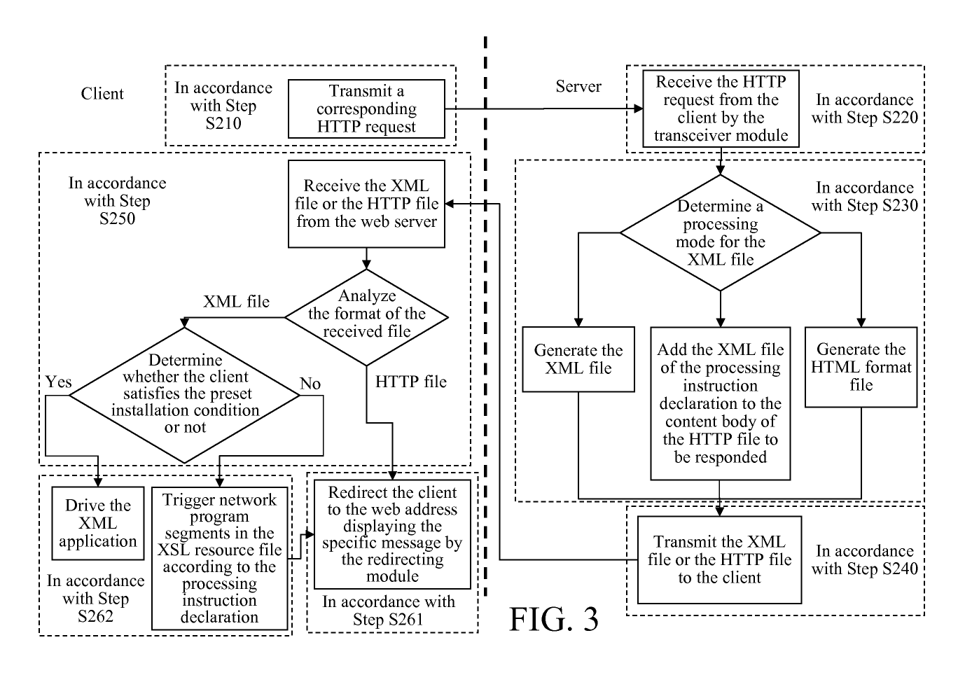

In order to describe the operations of the web server and the browser more clearly, a schematic view of an operating process of the web server and the browser is shown in FIG. 3.

In accordance with Step S210, when a user intends to download the XML file, the first transceiver module 112 transmits a corresponding HTTP request to the web server.

In accordance with Step S220, the transceiver module of the server processing unit 120 receives the HTTP request from the client.

In accordance with Step S230, the second analyzing module 122 analyzes the HTTP request, so as to determine a processing mode for the XML file. The determination results are as follows. If it is analyzed by the second analyzing module 122 that the client satisfies a preset installation condition, the XML file is generated. If it is analyzed by the second analyzing module 122 that whether the client satisfies the preset installation condition or not is not known, the file processing module 124 adds the XML file of the processing instruction declaration to the content body of the HTTP file to be responded. If it is analyzed by the second analyzing module 122 that the client is unidentifiable or other exceptional situations occur, the HTML format file is generated. The generated XML file is transmitted to the file processing module 124, and is packaged by the file processing module 124. When it is acquired from the HTTP request that the client is unidentifiable or other exceptional situations occur, the file processing module 124 generates a file in an HTTP file format, and packages the HTTP file.

In accordance with Step S240, the transceiver module of the server processing unit 120 transmits the XML file or the HTTP file to the client. The transceiver module of the browser processing unit 110 receives the XML file or the HTTP file from the web server.

In accordance with Step S250, the determination module 113 analyzes the format of the received file.

In accordance with Step S261, if the received file is the HTTP file, the redirecting module 114 redirects the web browser of the client to the web address displaying the specific message.

In accordance with Step S262, if the received file is the XML file, the determination module 113 determines whether the client satisfies the preset installation condition or not. If the client satisfies the preset installation condition, according to a preference sequence of processing the data format by the operating system, the browser processing unit 110 drives the XML application in a non-intrusive manner. If the client does not satisfy the preset installation condition, according to the preference sequence of processing the data format by the operating system, the redirecting module 114 triggers network program segments in the XSL resource file according to the processing instruction declaration. Then, the redirecting module 114 redirects the web browser of the client to the web address displaying the specific message.

According to the system and the method of the present invention, if the XSL application is installed on the web browser of the client, the XSL application is automatically driven through the OLE technology in a non-intrusive manner. If the XSL application is not installed on the web browser of the client, the web browser of the client is redirected to a web address displaying a message of “XSL application is not installed”. In the present invention, configuration information about the operating system of the web browser of the client is detected in a non-intrusive manner of high security.

What is claimed is:

1. A method for driving an Extensible Markup Language (XML) application on a web browser, the method comprising:
(a) sending a Hypertext Transfer Protocol (HTTP) request by the web browser of the client to a corresponding web server;
(b) performing the following steps by the web server on a content body of an HTTP file after receiving the HTTP request from the web browser of the client;
(b-1) adding an XML file of a processing instruction declaration to the content body of the HTTP file to be responded;
(b-2) adding a set value to a response header of the XML file of the processing instruction declaration, wherein the set value is used for recording a Multipurpose Internet Mail Extensions (MIME) protocol type registered in an operating system of the web browser of the client through the XML application; and
(b-3) returning the responded HTTP file to the web browser of the client after adding a content disposition declaration to the response header; and
(c) performing the following steps by the web browser of client after receiving the HTTP file responded by the web server:
(c-1) determining whether the XML application is installed on the web browser of the client or not;
(c-2) triggering the XML application to interpret the HTTP file, if the XML application is installed; and
(c-3) redirecting the web browser of the client to a web address displaying a specific message, if the XML application is not installed.

2. The method according to claim 1, wherein the HTTP file responded by the web server is a packet structure composed of the response header and the content body.

3. The method according to claim 1, wherein in Step (b-3), after the content disposition declaration is added to the response header of the responded HTTP, a filename extension of the HTTP file is made into an XML format.

4. The method according to claim 1, wherein a triggering mode in Step (c-2) is to automatically drive the XML application through a Microsoft's Object Linking and Embedding (OLE) technology according to a filename extension of the HTTP and the MIME protocol type.

5. The method according to claim 1, wherein the specific message in Step (c-3) is a word description for notifying the user that the XML application is not installed on the web browser of the client.

6. A system for driving an Extensible Markup Language (XML) application on a web browser, applied to perform data exchange between a web browser of the client and a web server, the system comprising:
a browser processing unit, installed on the web browser of the client, and comprising:
a registration module, for registering a filename extension and a Multipurpose Internet Mail Extensions (MIME) protocol type related to the XML application in an operating system of the web browser of the client;
a first transceiver module, for transmitting a request of downloading a Hypertext Transfer Protocol (HTTP) based on an XML file, and receiving an HTTP file returned by the web server;
a determination module, for determining whether the web browser of the client satisfies a preset installation condition or not, and triggering the XML application to interpret the HTTP file if the web browser of the client satisfies the preset installation condition, wherein the preset installation condition is that the XML application is installed on the web browser of the client, and the registration module registers the filename extension and the MIME protocol type; and
a redirecting module, for performing a corresponding process according to a determination result of the determination module, wherein if the determination module determines that the web browser of the client does not satisfy the preset installation condition, the redirecting module redirects the web browser of the client to a web address displaying a specific message; and
a server processing unit, installed on the web server, and comprising:
a second transceiver module, for receiving the HTTP request sent by the web browser of the client, and transmitting the processed HTTP file;
a file processing module, for generating the XML file; and
an analyzing module, for analyzing the HTTP request, wherein when the web browser of the client satisfies the preset installation condition, the file processing module generates a standard XML file, and the HTTP file is the standard XML file.

7. The system for driving an XML application on a web browser according to claim 6, wherein the server processing unit further comprises a configuration setting module, for adding to a configuration profile of the web server a set value the same as the MIME protocol type registered in the operating system of the web browser of the client.

8. The system for driving an XML application on a web browser according to claim 6, wherein if it is analyzed by the analyzing module that whether the web browser of the client satisfies the preset installation condition or not is not known, the file processing module further generates the XML file added with a processing instruction declaration, and the HTTP file is the XML file added with the processing instruction declaration.

9. The system for driving an XML application on a web browser according to claim 6, wherein if it is analyzed by the analyzing module that the web browser of the client is unidentifiable, the file processing module further generates a Hypertext Markup Language (HTML) format file, and the HTTP file is the HTML format file.

10. The system for driving an XML application on a web browser according to claim 6, wherein the redirecting module triggers an Extensible Style Language (XSL) resource file event according to the processing instruction declaration of the XML file, so as to redirect the web browser of the client to the web address displaying the specific message.

11. The system for driving an XML application on a web browser according to claim 6, wherein a triggering mode is to automatically drive the XML application through a Microsoft's Object Linking and Embedding (OLE) technology according to the filename extension of the HTTP and the MIME protocol type.
